(19) United States
(12) Patent Application Publication
(10) Pub. No.: US 2009/0070655 A1
(43) Pub. Date: Mar. 12, 2009

(54) Method for Generating an ECC Code for a Memory Device

(75) Inventor: Sheng-I Hsu, Changhua Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Jhubei City (TW)

(21) Appl. No.: 12/103,160

(22) Filed: Apr. 15, 2008

Related U.S. Application Data
(60) Provisional application No. 60/971,328, filed on Sep. 11, 2007.

(51) Int. Cl. G06F 12/16; G06F 11/10

(52) U.S. Cl. 714/763; 714/E11.032

(57) ABSTRACT

A method for generating an ECC for a flash memory device is provided. The flash memory device only supports flash memories with low-level ECC technology, such as SLC (single-level cell) flash memories. By using a controller with an ECC engine, the flash memory device can directly generate a correct ECC for itself when it reads data from flash memories with high-level ECC technology, such as MLC (multi-layer cell) flash memories. Thus the flash memory device can also support flash memories with high-level ECC technology and reduce the time of reading data.

This application claims the benefit of Provisional Application No. 60/971,328 filed on Sep. 11, 2007.

### CROSS-REFERENCES TO RELATED APPLICATIONS

Not applicable.

### BACKGROUND OF THE INVENTION

1. Field of the Invention

The present invention relates to a method for generating an ECC for a memory device. More particularly, the present invention relates to a method for generating an ECC for a memory device which only supports low-level ECC technology.

2. Descriptions of the Related Art

Error-correction-code (ECC) has been used for decades and has an excellent track record in several applications. For example, a flash memory with single-level cell (SLC) technology uses Hamming ECC which performs 1-bit error correction. A host controlling the flash memory requires that data transmitted from the flash memory to the host have to bring a Hamming ECC, and then the host can correct the data according to the Hamming ECC, if necessary. However, when high-level and more complicated technology is applied for flash memories, such as multilevel-cell (MLC) technology where each flash memory cell stores two or more bits of data, low-level ECC technology, such as Hamming ECC, can not perform a correct track record function and provide enough information to correct data if necessary. Therefore, high-level ECC technology, such as Reed-Solomon (RS) ECC, gradually becomes popularly used to provide 8-bit error correction capabilities for advanced flash technology.

For some flash memory card specification, such as MMC 2.0 and SD 2.0, the flash memory device applying high-level ECC can correct the data before transmit the data to the host. Thus the data transmitted to the host do not need an ECC. However, to meet the requirement for the hosts that expect the data with an ECC, the flash memory device with high-level ECC still has to generate an ECC, and some problems may occur.

For example, when a host reads data from a flash memory device, and the host requires an ECC for correcting reading data, the flash memory device has to provide the ECC.

In FIG. 1, data 10 are from the flash memory and comprise main data 11, spare data 12, and a RS ECC 13. The data 10 are then transmitted to a controller 20 of the flash memory device and the controller 20 processes the data 10 and outputs processed data 30 to the host. The data 30 comprise main data 31, spare data 32, and a HM ECC 33.

The controller 20 comprises a buffer 21, a spare register 22, an ECC engine 23, and a HM ECC encoder 24. The main data 11 are transmitted to the buffer 21 and the ECC engine 23, as well as the spare data 12 are transmitted to the spare register 22 and the ECC engine 23. The RS ECC 13 is transmitted to the ECC engine 23. After the ECC engine 23 receives the main data 11, the spare data 12 and the RS ECC 13, it generate an update message 104 to the buffer 21 and the spare register 22 for correcting the main data 11 and the spare data 12 respectively.

Since the host requires an HM ECC, the HM ECC encoder 24 then generates the HM ECC 33 according to the updated main data and the updated spare data from the buffer 21 and the spare register 22 respectively. The controller 20 outputs the updated main data as the updated main data 31, and outputs the updated spare data as the updated spare data 32. The host then retrieves the updated main data 31, the updated spare date 32, and the HM ECC 33. It takes two operations of error correction algorithm, which costs operation time.

Thus, it is important to generate a correct ECC without wasting more time to read data more than once for a memory device which only supports low-level ECC technology.

### SUMMARY OF THE INVENTION

The primary objective of this invention is to provide a method for generating a low-level ECC for a memory device according to a high-level ECC.

By using a controller with an ECC engine which applies high-level ECC technology, the memory device can directly generate a correct ECC for itself when it reads data from memories. And the controller also generates a low-level ECC according to the high-level ECC. Thus the memory device can also support memories with high-level ECC technology, and reduce the time of data reading.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram of the previous invention during the period of reading data;

FIG. 2 is a block diagram of the present invention during the period of reading data;

FIG. 3 is a block diagram of the present invention during the period of writing data;

### DESCRIPTION OF THE PREFERRED EMBODIMENT

In the descriptions that follow, the present invention will be described in reference to embodiments that generating a low-level ECC according to a high-level ECC. However, embodiments of the invention are not limited to any particular environment, application or implementation. Therefore, the descriptions of the embodiments that follow are for purposes of illustration and not limitation.

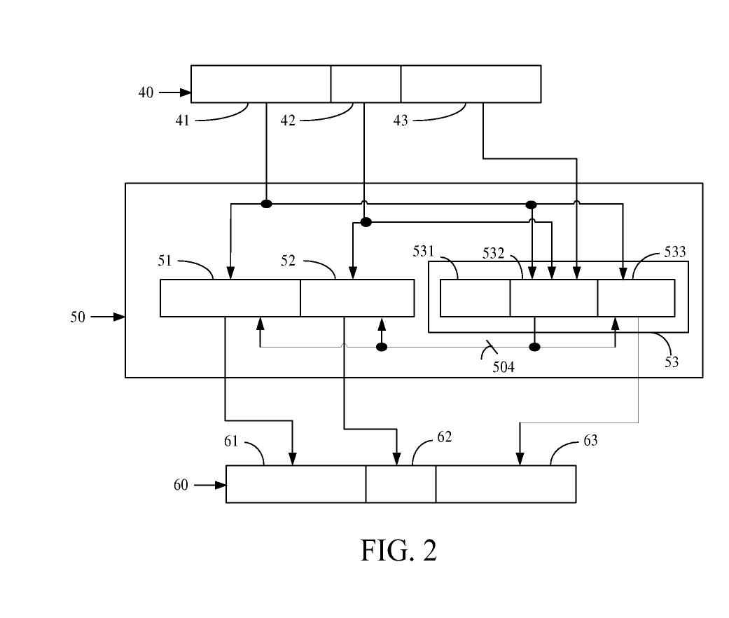

FIG. 2 illustrates a block diagram of processing data from a memory device to a host, in other words reading steps, via a controller by applying the present invention. The embodiment takes a flash memory device as an example, however, it does not intend to limit the present invention, the memory device that require a low-level ECC can apply the present invention. The flash memory device may be eXtreme Digital Picture (xD) card, Smart Media card or Memory Stick card. The flash memory device applies a high-level error correction algorithm, herein a Reed-Solomon (RS) algorithm, to generate a RS ECC and a low-level ECC, herein a Hamming ECC. In other embodiment, the high-level error correction algorithm may be a Bose-Chaudhury-Hocquenghem (BCH) algorithm or other proper algorithms.

A controller 50 receives data 40 from the flash memory device, and processes the data 40 into updated data 60 for being transmitted to the host. The data 40 comprises main data 41, spare data 42, and a RS ECC 43. The controller 50 comprises a buffer 51, a spare register 52, and an ECC engine 53. The updated data 60 comprises updated main data 61, updated spare data 62, and a HM ECC 63.

The ECC engine 53 further comprises a RS ECC decoder 532, a HM ECC encoder 533, and a RS ECC encoder 531, wherein the RS ECC decoder 532 and the HM ECC encoder 533 are used for reading steps and the RS ECC encoder 531 is used for writing steps. The buffer 51 and the RS ECC decoder 532 both receive the main data 41, as well as the spare register 52 and the RS ECC decoder 532 both receive the spare data 42, and the RS ECC decoder 532 also receives the RS ECC 43. The RS decoder 532 then decodes the main data 41 and the spare data 42 by a RS algorithm according to the RS ECC 43 and generates update message 504 to the buffer 51, the spare register 52, and the HM ECC encoder 533 for respectively updating the main data, updating the spare data, and generating the HM ECC 63. The detail of how to generate updated main data 61, the updated spare data 62 and the HM ECC 63 will be described hereinafter.

According to the RS ECC 43, the RS ECC decoder 532 can detecting error addresses of the main data 41 and the spare data 42 by a corresponding decoding algorithm, in this embodiment a RS algorithm, and generates the update message 504 which records all error addresses of the main data 11 and spare data 42. Finally, the RS ECC decoder 532 outputs the update message 504 to the buffer 51 and the spare register 52 for amending data, and to the HM ECC encoder 533 for generating the correct HM ECC.

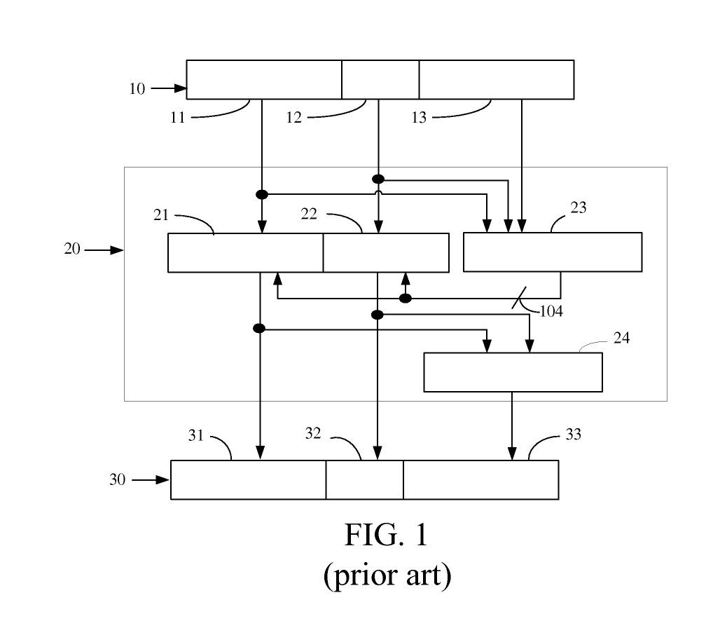

The updated main data are then outputted and denoted as the updated main data 61, as well as the updated spare data are then outputted and denoted as the updated spare data 62. Since the main data 41 and the spare data 42 are both updated by the update message 504 which is generated by the RS ECC decoder 532, the updated main data 61 and the updated spare data 62 both contain no error data because the update message 504 can provide more information for error correction than the update message 104 in FIG. 1. Meanwhile, the HM ECC 63 is generated according to the update message 504; therefore the HM ECC 63 indicates no error of the updated main data 61 and the updated spare data 62.

HM ECC 63 consists of column parities (CP) and line parities (LP). Following description takes line parities as an example to explain how the HM ECC 63 is generated according to the update message 504. Refer to Table 1 below; a line parity is generated according to bits of each byte by an XOR operation. For example, byte 0 is a value of eight bits by an XOR operation and equals to 0, byte 1 is a value of eight bits by an XOR operation and equals to 0, byte 2 is a value of eight bits by an XOR operation and equals to 1, byte 3 is a value of eight bits by an XOR operation and equals to 0, similarly, byte 255 is a value of eight bits by an XOR operation and equals to 1, and so on.

TABLE 1

| | bit | XOR |
|---|---|---|
| byte | value | value |
| 0 | 00110101 | 0 |
| 1 | 10101100 | 0 |
| 2 | 01110110 | 1 |
| 3 | 11010001 | 0 |

.
.
.
.

| | | |
|---|---|---|
| 255 | 11110010 | 1 |

When byte of data is error, group value of bytes would be wrong either. Refer to Table 2 below, LP1 is a group value of line parities of bytes 1, 3, 5, 7 . . . and 255 by an XOR operation, LP1′ is a group value of line parities of bytes 0, 2, 4, 6, 8 . . . and 254 by an XOR operation, LP2 is a group value of line parities of bytes 0, 1, 4, 5, 8, 9 . . . and 252, 253 by an XOR operation, LP2′ is a group value of line parities of bytes 2, 3, 6, 7, 10, 11 . . . and 254, 255 by an XOR operation, similarly, LP128 is a group value of line parities of bytes 128, 129, 130, . . . and 255 by an XOR operation, LP128′ is a group value of line parities of bytes 0, 1, 2, 3, . . . and 127 by an XOR operation, and so on. Please note that the XOR values of the aforementioned LPs may be error, and correction aimed at the XOR values would be explained later.

TABLE 2

| | corresponding | XOR |
|---|---|---|
| group | bytes | value |
| LP1 | 1, 3, 5, 7, 9, . . . 255 | 0 |
| LP1′ | 0, 2, 4, 6, 8, . . . 254 | 0 |
| LP2 | 0, 1, 4, 5, 8, 9, . . . 252, 253 | 0 |
| LP2′ | 2, 3, 6, 7, 10, 11, . . . 254, 255 | 0 |

.
.
.
.

| | | |
|---|---|---|
| LP128 | 128, 129, 130, . . . 255 | 1 |
| LP128′ | 0, 1, 2, 3, . . . 127 | 0 |

Refer to Table 3, if the update message 504 records that byte 1 of data is error and the value of the XOR operation is 1, all group values which comprises byte 1, including at least LP1, LP2, and LP128′, should be converted from 1 to 0 or from 0 to 1. On the other hand, if the update message 504 records that byte 1 of data is error and the value of the XOR operation is 0, all group values which comprises byte 1 remain the same. Therefore, if an error of two or more bits is occurred, it can not be detected by line parities. This is also the reason that HM ECC 63 can not detect an error of two or more bits.

TABLE 3

| | corresponding | XOR |
|---|---|---|
| group | bytes | value |
| LP1 | 1, 3, 5, 7, 9, . . . 255 | 0=>1 |
| LP1′ | 0, 2, 4, 6, 8, . . . 254 | 0 |
| LP2 | 0, 1, 4, 5, 8, 9, . . . 252, 253 | 0=>1 |
| LP2′ | 2, 3, 6, 7, 10, 11, . . . 254, 255 | 0 |

.
.
.
.

| | | |
|---|---|---|
| LP128 | 128, 129, 130, . . . 255 | 1 |
| LP128′ | 0, 1, 2, 3, . . . 127 | 0=>1 |

Because the HM ECC 63, the updated main data 61 and the updated spare data 62 are generated according to the update message 504, the HM ECC 63 can correspond to the updated main data 61 and the updated spare data 62. Therefore, even the host corrects the updated main data 61 and the updated spare data 62 by using the HM ECC 63, according to request of specification, the output will be correct since they are already correct data. By the controller 50, the RS ECC 43 which is high level ECC can be converted to the HM ECC 63 which is low level ECC correctly.

It is clearly to understand that the controller 50 can generate the HM ECC 63 by the update message 504, and don't have to further retrieve updated main data 61 and updated spare data 62 for generating the HM ECC 63. Compared with the prior art, the HM ECC 63 can be retrieved at the same time without other steps to read updated main data 61 and updated spare data 62 again in this invention. Therefore the reading steps will be more efficient.

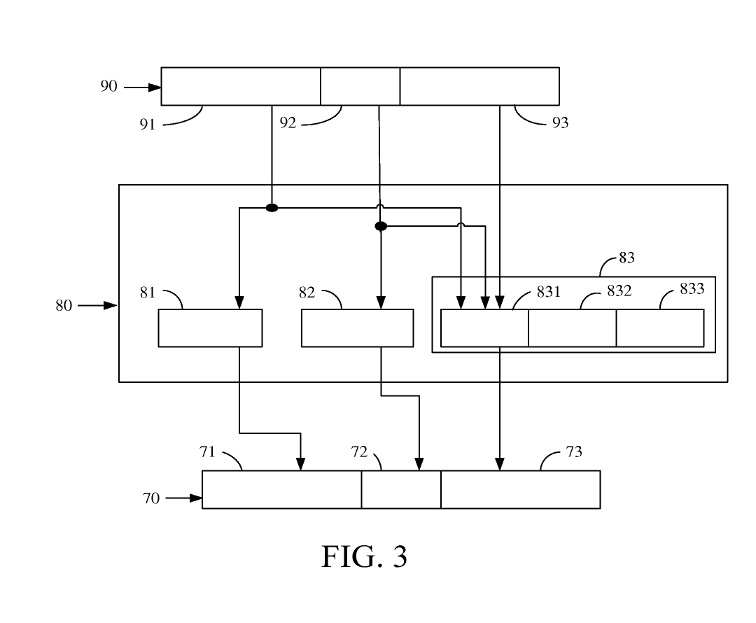

FIG. 3 illustrates a block diagram of processing data from the host to the flash memory device, in other words writing steps, via the controller by applying the present invention.

FIG. 3 illustrates another block diagram of the present invention during the period of writing data from a device host to a flash memory. The controller 80 comprises a buffer 81, a spare register 82, and an ECC engine 83. The ECC engine 83 comprises a RS encoder 831, a RS decoder 832 and a HM encoder 833. When the host starts to write data to the flash memory, the main data 91 and the spare data 92 are temporarily stored to the buffer 81 and the spare register 82 respectively. Meanwhile, the main data 91 and the spare data 92 are spontaneously transmitted to a RS ECC encoder 831, as well as the HM ECC 93.

Without any process, the buffer 81 writes the main data 91 and the spare data 92 as the main data 71 and the spare data 72 to the flash memory. At the same time, the RS ECC encoder 831 generates the RS ECC 73 according to the main data 91 and the spare data 92 by a RS encoding algorithm, and writes the RS ECC 73 to the flash memory.

It is realized that by applying the present invention, the controller of the memory can generate a low-level ECC, such as Hamming ECC, according to a high-level ECC, such as RS ECC. By retrieving the high-level ECC, the controller can directly generate the low-level ECC without retrieving updated data, which saves cost as well as processing time.

The above disclosure is related to the detailed technical contents and inventive features thereof. People skilled in this field may proceed with a variety of modifications and replacements based on the disclosures and suggestions of the invention as described without departing from the characteristics thereof.

What is claimed is:

1. A method of generating a low-level ECC (Error-Correction-Code) for a memory device, comprising the steps of:
receiving data from the memory device, wherein the data comprises main data, spare data and an high-level ECC;
detecting error addresses of the main data and the spare data according to the high-level ECC by a decoding algorithm;
generating an update message according to the error addresses; and
generating the low-level ECC according to the update message.

2. The method as claimed in claim 1, wherein the memory device is a flash memory device.

3. The method as claimed in claim 1, wherein the memory device is one of an eXtreme Digital Picture (xD) card, a Smart Media card and a Memory Stick card.

4. The method as claimed in claim 1, wherein the low-level ECC is a Hamming ECC.

5. The method as claimed in claim 1, wherein the high-level ECC is a Reed-Solomon ECC, and the decoding algorithm is a Reed-Solomon algorithm.

6. The method as claimed in claim 1, further comprising the step of updating the main data and the spare data by the update message.

7. The method as claimed in claim 6, wherein the updated main data and the updated spare data contain no error data.

8. The method as claimed in claim 7, wherein the low-level ECC indicates no error of the updated main data and the updated spare data.

9. A controller for generating a low-level ECC for a memory device, comprising:
a buffer for receiving main data of the memory device;
a spare register for receiving spare data of the memory device; and
an ECC engine for generating an ECC, comprising:
an ECC decoder for receiving the main data, the spare data and an high-level ECC of the memory device, detecting error addresses of the main data and the spare data according to the high-level ECC by a decoding algorithm, and generating an update message according to the error addresses;
an ECC encoder for generating the low-level ECC according to the update message.

10. The controller as claimed in claim 9, wherein the memory device is a flash memory device.

11. The controller as claimed in claim 9, wherein the memory device is an eXtreme Digital Picture (xD) card, a Smart Media card or a Memory Stick card.

12. The controller as claimed in claim 9, wherein the low-level ECC is a Hamming ECC.

13. The controller as claimed in claim 9, wherein the high-level ECC is a Reed-Solomon ECC, and the decoding algorithm is a Reed-Solomon algorithm.

14. The controller as claimed in claim 9, wherein the ECC decoder further transmits the update message to the buffer and the spare register for updating the main data and the spare data respectively.

15. The controller as claimed in claim 14, wherein the updated main data and the updated spare data contain no error data.

16. The controller as claimed in claim 15, wherein the low-level ECC corresponds to the updated main data and the updated spare data.
